(19) United States
(12) Patent Application Publication
(10) Pub. No.: US 2015/0186603 A1
(43) Pub. Date: Jul. 2, 2015

(54) Mobile Medical Documentation System

(71) Applicant: Trigram Mobile, LLC, Garden Grove, CA (US)

(72) Inventor: Joseph M. Buckle, Garden Grove, CA (US)

(21) Appl. No.: 14/580,071

(22) Filed: Dec. 22, 2014

Related U.S. Application Data
(60) Provisional application No. 61/921,335, filed on Dec. 27, 2013.
(60) Provisional application No. 61/921,358, filed on Dec. 27, 2013.
(60) Provisional application No. 61/936,813, filed on Feb. 6, 2014.

(51) Int. Cl. G06F 19/00; G06F 17/24

(52) U.S. Cl. CPC G06F 19/322; G06F 17/248

(57) ABSTRACT

A mobile medical document system is described which allows a user to access, create, and edit medical record data on a server. In one embodiment, clinicians access and input this data via mobile computing devices on which a mobile medical records application is executed. Customized template forms for use in the mobile medical records application can be created with a plug-in for a word processor application.

### RELATED APPLICATIONS

This application claims priority to U.S. Provisional Application Ser. No. 61/921,335 filed Dec. 27, 2013 entitled A Mobile Documentation System; to U.S. Provisional Application Ser. No. 61/921,358 filed Dec. 27, 2013 entitled A Method For Managing A Mobile Documentation System; and to U.S. Provisional Application Ser. No. 61/936,813 filed Feb. 6, 2014 entitled Wound Monitoring System, all of which are hereby incorporated herein by reference in their entireties.

### BACKGROUND OF THE INVENTION

The present invention relates generally to the mobile documentation market where the use of existing paper based form and data capturing solutions are being replaced with an electronic means.

Traditional industries like the medical industry have developed many practices and procedures over the years. Many of these practices include forms that are structured to capture a specific type of data in a specific manner. More specifically, these forms are typically used such that data can be captured by handwriting.

As computers, file systems, and computer servers have advanced they are impacting these traditional industries. A resulting desire is to replace the method of using hand writing to capture data with electronic format such that it can be more efficiently read, managed and archived electronically. This task becomes very challenging for the individuals like doctors, nurses, nurse practitioners and care givers who are creating and entering the data, and who are used to the traditional practices and procedures that include forms that were meant to be used such that data can be captured by handwriting.

Additionally, in the event a medical professional needs to visit a patient at a remote site, the medical professional would need to carry the patient's physical file, which would contain the medical record of the patient's care. For older patients, their files can be quite large and therefore carrying around patient's files can be difficult and time consuming.

### SUMMARY OF THE INVENTION

In one embodiment, an electronic data entry system is described that more closely mimics the look and feel of the traditional forms, while providing additional easier access and greater functionality. This system enables one to create or recreate an electronic form in a standard word editor, easily identify the areas of data input, save the form in a fashion that can be read by a custom database server, the customer server then pushes the form down to the mobile computing device such as a tablet for data entry.

In one embodiment, the system is configured to include a main database server and a mobile device application. These devices are all logical although they reside on a computer. The main database server provides a centralized logical location that is configured to authenticate users and devices, store data, store forms and templates, manage data as the system administrator desires, and create server forms and templates created by a user. The mobile device includes an application to communicate with the main database server, display forms and fields to the user, enable data input to the fields in the forms, store data and forms locally and upload data and forms to the main database server.

One aspect of the present invention is realized when the system is in use by medical professionals. Although the system can be enabled to act like a traditional form where data is written by use of an electronic pen or stylus, one aspect of the present invention allows the further standardization of terms. For example, in the case of wound care, the mobile documentation system and form can be configured such that the medical professional must choose a body part and actually point to the body part where the wound resides. Often times in handwritten forms the area of the body is not accurately specified by the medical professional which leads to inaccurate management of the treatment, misappropriated billing and even inaccurate prescriptions.

Another aspect of the present invention relates to the system's use in a rural area with no internet access or ability for the mobile device to communicate with the main database server. This aspect is realized by the system enabling the records be loaded and saved locally in the mobile device such that all the medical records can be available for review by the medical professional in the rural area. Using the same example of wound care, in a rural area where the medical professional needs to travel to the patient and internet access is not available the medical professional may still have all the previous medical data for the patient stored on the mobile device prior to the visit such that the medical professional may review the previous medical records for changes in the condition of the wound.

Another aspect of the present invention relates to a method for managing a mobile documentation system. Although this one embodiment relates to medical group that includes multiple doctors' offices and patients that are not mobile or are located in a rural area or where a medical professional may use a tablet for reviewing and documenting a patient visit but there are other related industries where mobile document and or data collection is required and the current system and method could be used.

Yet another aspect of the present invention relates to the method of providing a system that enables a medical professional with the ability to review a patient's medical records and insert additional data into the medical record while away from the medical professional's office where physical or electronic files may be stored.

Another aspect of the present invention relates to the method of providing a system that enables a medical professional the ability to review a patient's medical records and insert additional data into the medical record when the patient visit occurs in a remote location without the ability to make an electronic connection with the patient's electronic file and without the need to carry a physical copy of the patient's medical records.

Another aspect of the present invention relates to the method of categorizing patient's data to include patient communities where the community is a logical group of patients that suffer from the similar illnesses.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1 illustrates a medical records management system according to the present invention.

FIG. 2-8 illustrate various aspects of a medical form template creation plug-in for a word processor.

FIG. 9 illustrates a flow chart for a process of converting a word processing document into a medical template file.

FIGS. 10-18 illustrate various views of a mobile application for accessing, creating, and editing patient medical records.

FIG. 19 illustrates a flow chart for a method of determining a size of a patient wound.

FIG. 20 illustrates one embodiment for a wound-measuring interface.

FIG. 21 illustrates one embodiment for a wound-measuring interface.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

The present invention is generally directed to a method and system for creating, storing, and distributing medical forms and medical data. This allows a clinician or medical professional, such as a doctor or nurse, to enter patient data, create forms from predetermined templates, upload data, and even download a patient's entire electronic medical file. Additionally, this data can be accessed via a mobile computing device, such as a tablet, allowing the clinician to input and access this data in an office or a remote setting, such as a patient home or nursing home.

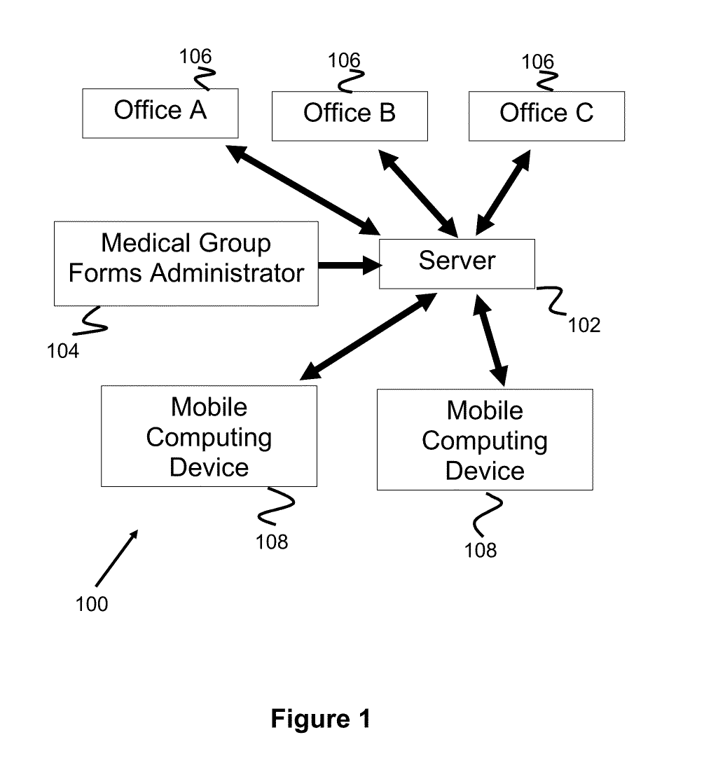

One example embodiment of this system 100 is conceptually illustrated in FIG. 1. The server 102 is a computing device such as a single computer server, several computer servers configured to act together, or similar devices, in which medical forms and medical data are stored. A medical group forms administrator 104 operates a computing device to design various medical forms (as discussed later in this specification) and uploads these forms to server 102 (e.g., via an internet connection), where they can be accessed by remote medical offices 106 (e.g., doctor's offices or hospitals) and mobile computing devices 108. Optionally, this data can be uploaded (e.g., via an internet connection) back to the server 108.

In one example, the mobile computing device 108 is a touch-screen tablet, laptop, or similar mobile computing device. Preferably, each device at least has a processor, a display, an input device, a processor, and memory, and is further capable of executing software. Optionally, the mobile computing device 108 has a wireless communication device for wirelessly communicating with the server 102 at a remote location. However, the mobile computing device 108 may also lack such a communication device directly via a wired connection prior to traveling to a remote location. The mobile aspect of the mobile computing device allows a medical professional, such as a nurse, to travel to remote locations, such as a patient's home or a skilled nursing facility, to document a patient's medical condition.

In one embodiment, the server 102 is one or more computers having a processor capable of executing software, memory capable of storing data, and a data connection device (e.g., a wired or wireless Ethernet device). Preferably, all medical forms and patient data are managed by a medical records software which, among other things, stores and accesses the records in a database file that is located in the memory of the server 102 or that is accessible to the server 102 (e.g., a second server or storage device).

Preferably, the medical records software executed by the server 100 includes user accounts requiring a login and password from a user, and optionally a medical group ID that may distinguish between multiple medical groups using the server 100. Preferably, the medical records software further includes permissions that allow various levels of access and functionality, based on how these permissions are set. For example, a forms template administrator permission can be included that either allows or denies a user the ability to create and/or upload a form template to the server 102. In the present example, the medical group forms administrator 104 would have the forms template administrator permission set to allow creation/upload of forms.

The medical group forms administrator 104 preferably uses a computer to create a form template file that is uploaded to the server 102, converted into an appropriate format to display on the mobile computing device 108 and/or computers in offices 106, and then used by medical professional to create a user record or form. The template file includes a plurality of standard fields and data input types determined by the medical group forms administrator 104, allowing the format of patient data to be standardized.

In one embodiment, the medical group forms administrator 104 creates a template file by operating a template administering plug-in for word processing software. By allowing the template to be designed in a word processor application (e.g., Microsoft Word), the user can more easily generate a template with minimal additional learning. While aspects of the template administering plug-in are described below, it should be understood that stand-alone software with similar features could also be used to generate a template.

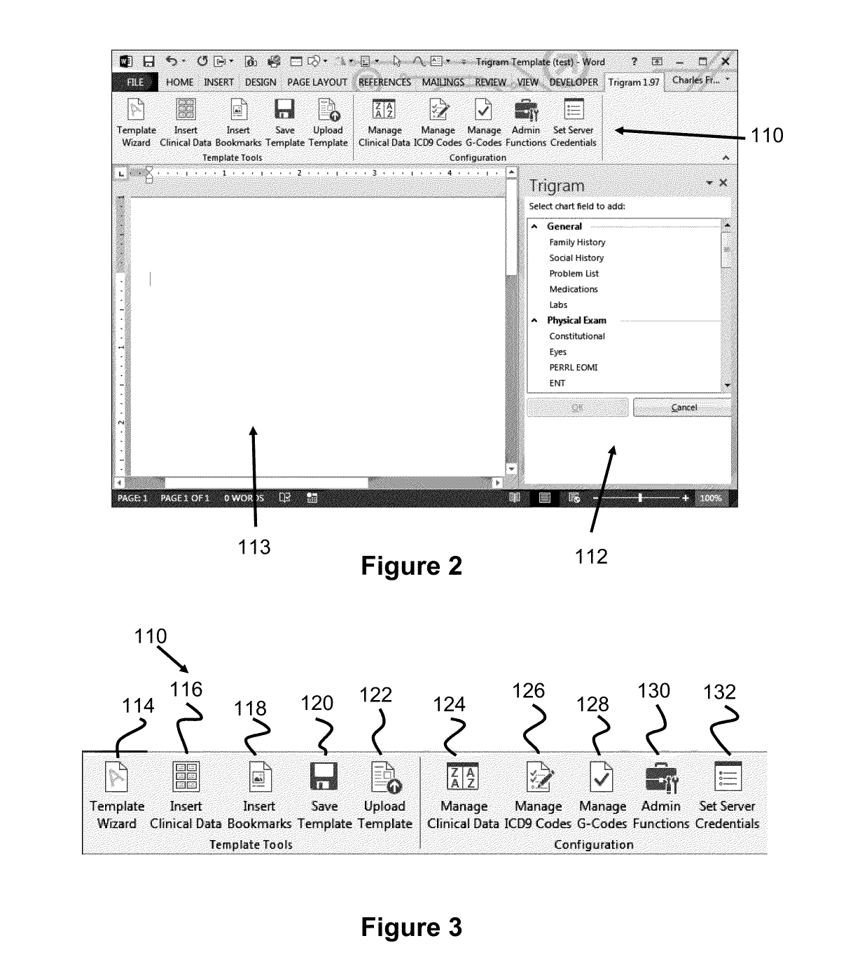

Once installed, the template administering plug-in provides the user with a template ribbon or bar area 110 across a top of the word processor user interface, as seen in FIG. 2. The template ribbon 110 includes a plurality of icons that, when clicked or activated by the user, perform various functionality related to template creation, as described in more detail below. Some of the icons display relevant selections or information in the side bar area 112, which is adjacent the word processing area 113 where a user would normally type text.

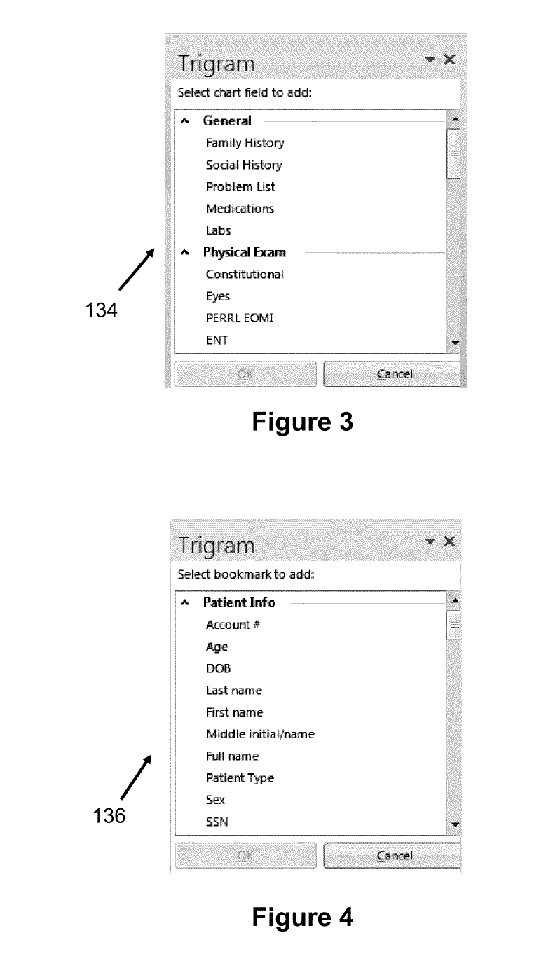

FIG. 3 illustrates one embodiment of the template ribbon 110 and its icons. Turning first to the template wizard icon 114, when actuated, this icon brings up a new window interface that allows a user to create a new blank template document, a new template document based on a previous template document, edit an existing template document, and delete a template document. When a new template document is selected, the user must enter a name for the template and can optionally set a password and a category.

Once this information is entered, the user is returned to the main word processing view shown in FIG. 2. When the insert clinical data icon 116 is actuated, the side bar area 112 displays a list of names of fields that can be added to the form template within the clinical data list box 134 (seen in FIG. 3). First, the user positions the cursor in the word processing area 113 where a desired field should be placed.

Next, the user selects a field from the clinical data list box 134, which causes a Microsoft content control item to be inserted into the word processing area 113. These content control items represent the location and data type that the health professional will enter data into. In this respect, the content control items for each of the entries in the clinical data list box 134 can be customized to receive a specific type of data, such as a nine digit number for a social security content control item or a drop-down list box with entries for “male” and “female” for the “Sex” content control.

It should be understood that the word processing area 113 functions as a normal word processing area. Hence, the user can mix normal text with content control items, creating headings and labels for the content control items.

In addition to content control items, a user can also insert bookmark items by actuating the insert bookmarks icon 118. Once actuated, the insert bookmarks icon 118 displays the bookmark list box 136 (FIG. 4), allowing the user to add bookmark items from a predetermined list. Once added, the end user of the finished template can quickly jump to specific areas of the template.

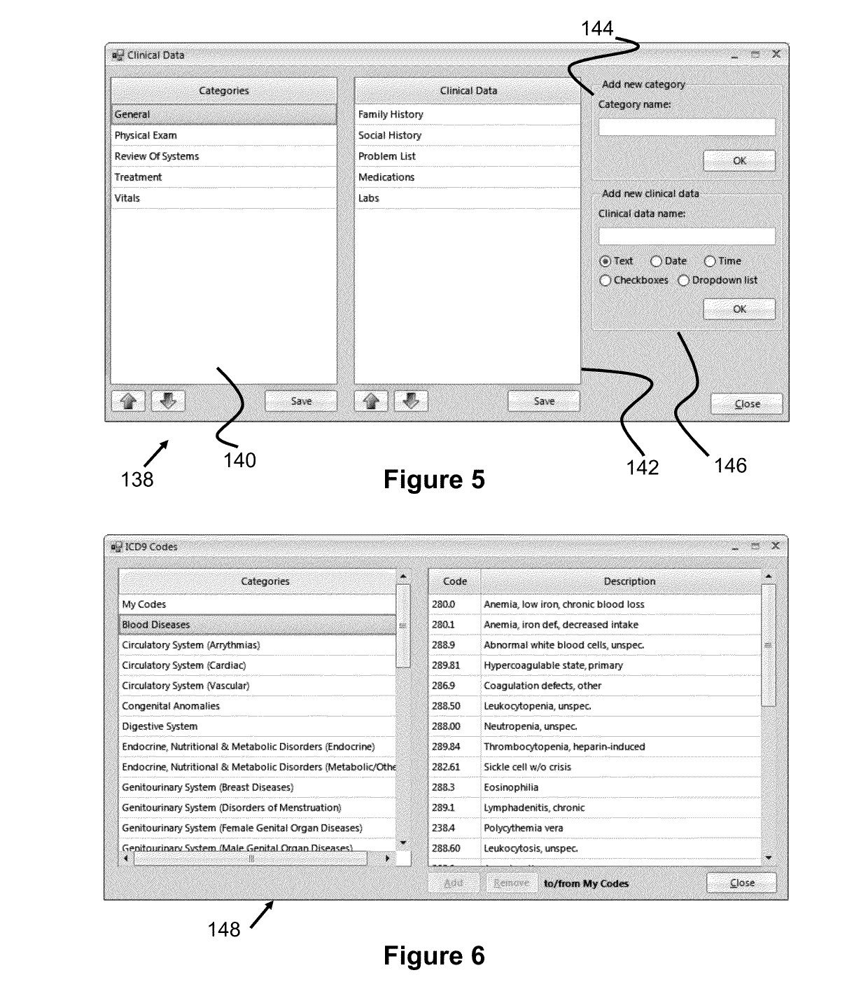

The items listed in the clinical data list box 134 can be added, deleted, or edited by actuating the manage clinical data icon 124 (FIG. 5). Once actuated, a clinical data management window 138 is displayed for the user, filtering clinical data entries by a first “categories” list 140, then in a data list boys 142 which contains the actual clinical data entries from a category. New clinical data items can be created by entering a category name into the category interface 144. The name of the new clinical data item can be entered in the text box of the new data interface 146, as well as the type of data that this item will include (e.g., text, date, time, checkboxes, dropdown list, etc.).

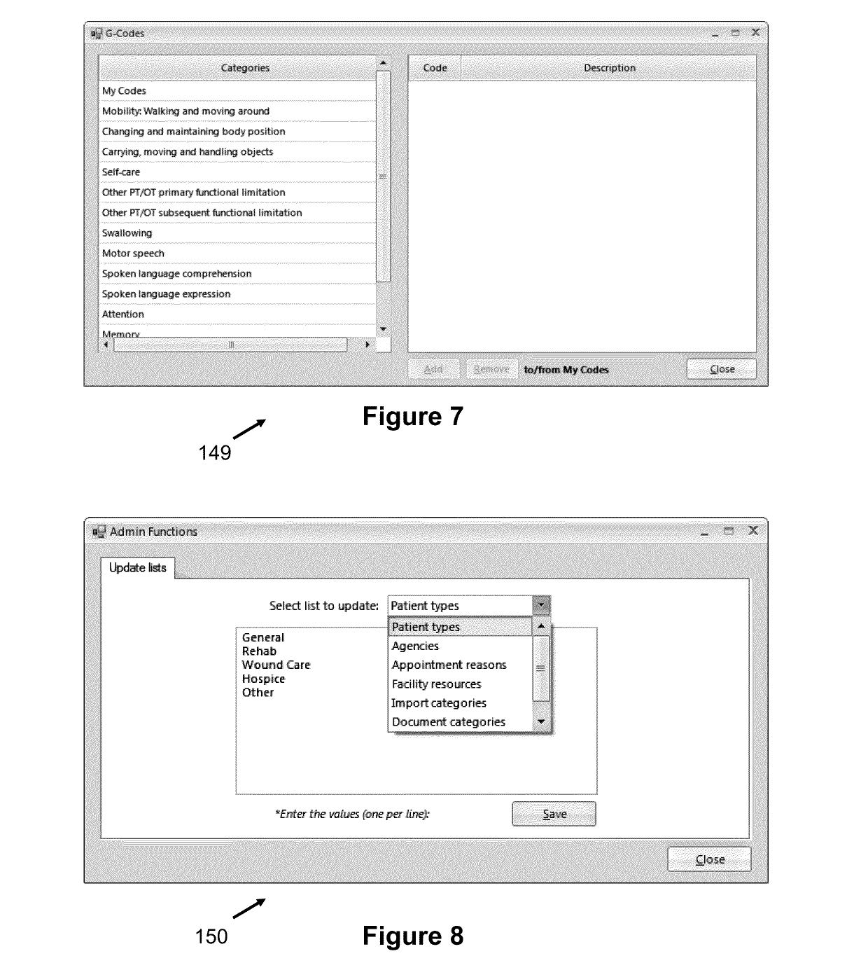

Returning to FIG. 3, the template ribbon 110 also includes icons for managing a list of medical codes, which can be added to documents for reference to assist in billing. Specifically, the manage ICD9 codes icon 126 displays billing code interface 148 (FIG. 6), while the manage G-codes icon 128 displays the G-code interface 149 (FIG. 7). Both interfaces allow a user to add specific codes to a “my codes” list for quick references.

The admin functions icon 130 displays a list update interface 150 (FIG. 8) which allows a user to update lists in various portions of the plug-in with new list entries (e.g., the clinical data list box 134).

Once the user has arranged the text and content control items on the document as desired, the save template icon 120 can be actuated to save the file locally as a Word document. Finally, the upload template icon 122 can be actuated to copy the template file to the server 102. In order to facilitate access to the server 102, the set server credentials icon 132 can be actuated to display a login interface, asking for account information such as a login name, password, and a company ID or tenant ID (e.g., in the event that a single server is shared by multiple companies).

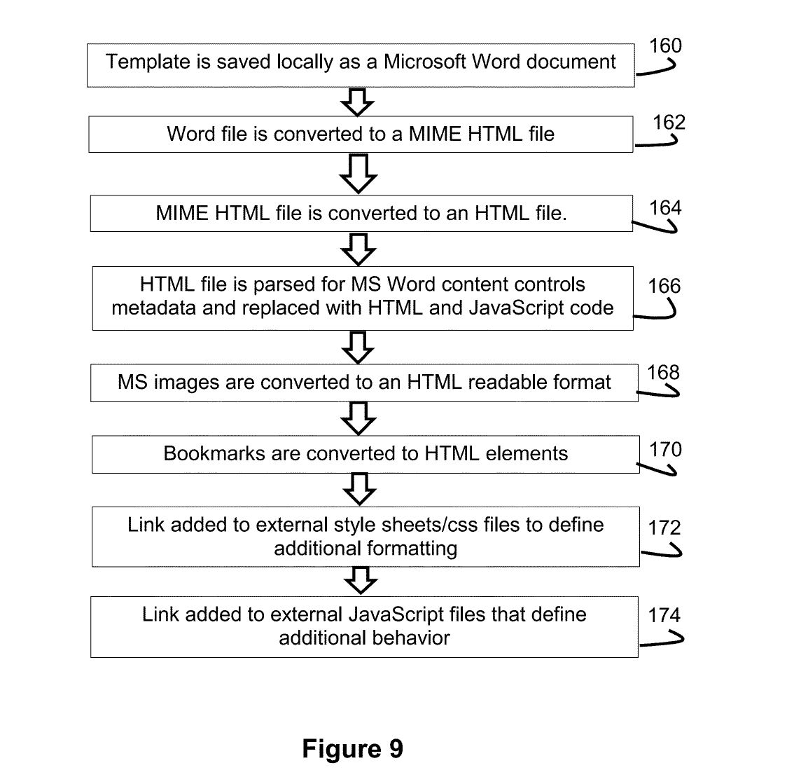

The flow chart in FIG. 9 describes the process of saving and converting the template from a Microsoft Word format to an HTML format that can be easily displayed on a mobile computing device 108 or web browser on a computer in an office 106. In one embodiment, these conversion steps are performed solely by the Microsoft Word plug-in software. In other embodiments, some or all of the steps can be performed by the server 102 or a separate, dedicated server.

With regard to element 160, the template file is initially saved as a Microsoft Word document (e.g., *.docx format). Next, in element 162, this MS Word document is converted to a webpage archive file format, such as MIME HTML (e.g., *.mht format). In element 164, the MIME HTML file is then converted to an HTML file.

Next, in element 166, the HTML file is parsed for MS Word content control metadata, which is replaced with HTML and JavaScript code. Specifically, each MS Word textfield content control with an HTML <div> element and an HTML5 contentEditable=‘true’ attribute for that element. The ID for that HTML element is parsed from its content control metadata to enable accessing the HTML element from JavaScript code. A similar procedure is performed for number and date fields, except that the HTML element <input> is used.

Next, each MS Word dropdown list content control metadata is replaced with an HTML <select> element. The ID for the HTML element is parsed from the content control metadata to enable accessing the HTML element from JavaScript code. Possible values (including a default value) for the dropdown list are parsed from the content control metadata and converted into an HTML <option> element that is added to the <select> element.

Next, each MS Word checkbox content control metadata is replaced with an HTML <input type=‘checkbox’> element. The ID for the HTML element is parsed from the content control metadata to enable accessing the HTML element from JavaScript code. The name attribute for the HTML element is also parsed from the content control metadata. Checkboxes belonging to the same group have the same name attribute value and therefore this name parsing allows JavaScript code to append HTML to handle a single-selection of checkboxes within the same group.

Next, in element 168, images that may have been inserted into the original Word document header are converted to base64 string representation format and inserted as HTML <img> elements to the HTML. Each <ung> element src attribute is set to the base64 string.

Next, in element 170, bookmarks (which are originally added to the Word document as static textfield content controls) are replaced with HTML <a> elements. Bookmarks that represent insertable photos from the mobile application are replaced with HTML <img> elements.

Next, in item 172, links to external style sheets (e.g., CSS) are added to the HTML template file to define additional formatting of the HTML template document. Finally, in element 174, links to external JavaScript files are added to the HTML template file to define additional behavior for handling user interaction with the document. For example, for a document template that requires a signature, JavaScript is used to allow the user to touch and write the signature on the document. In another example, JavaScript is used to to check which fields are updated, so they can be gathered and saved to the database. It should be understood that the steps and functions of FIG. 9 can be performed in any order.

Once the HTML template file has been created, it can be uploaded to the server 102 for storage and use by users with a mobile computing device 108 or on a computer in an office 106. Optionally, the original Word document and intermediate MIME HTML file can also be uploaded to the server 102.

Preferably, the HTML template file, and any additional data relating to the file (e.g., permissions, description, etc.), are stored in a database that is located on or is accessibly by the server 102. In one embodiment, the server 102 executes a CouchDB server program, allowing users with a mobile computing device 108 or on a computer in an office 106 to access template files via a webpage or via a mobile app using Couchbase lite.

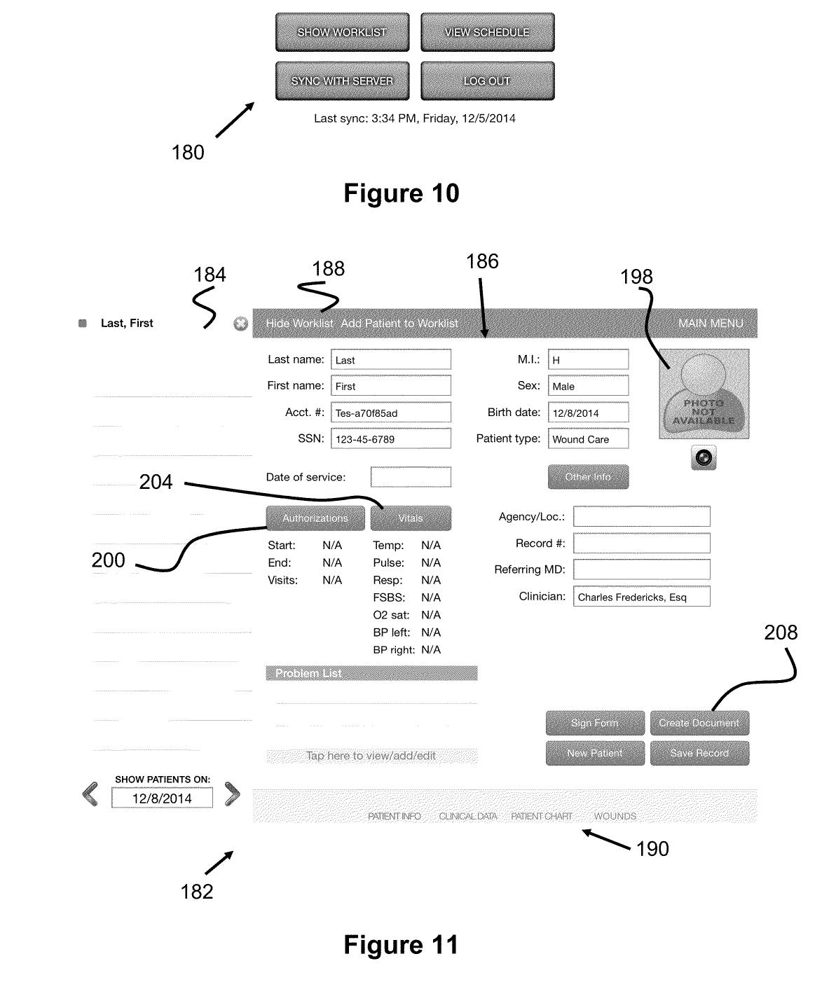

FIGS. 10-19 disclose various user interfaces of a mobile application that is downloaded to and executed by a mobile computing device 108, such as a tablet. This mobile application allows a user to initially provide login credentials to log into the server 102 to access and synchronize data (e.g., download new form templates, upload newly created patient forms, download updated patient records, etc.).

FIG. 10 illustrates a main menu interface 180 which includes a plurality of touch-activated button elements. The “view schedule” button element displays a calendar interface that displays appointments with patients, the “sync with server” button element synchronizes any relevant templates or completed form data with the server 102, the “log out” button element logs out of a specific user account, and the “show worklist” button element displays the worklist interface 182 shown in FIG. 11.

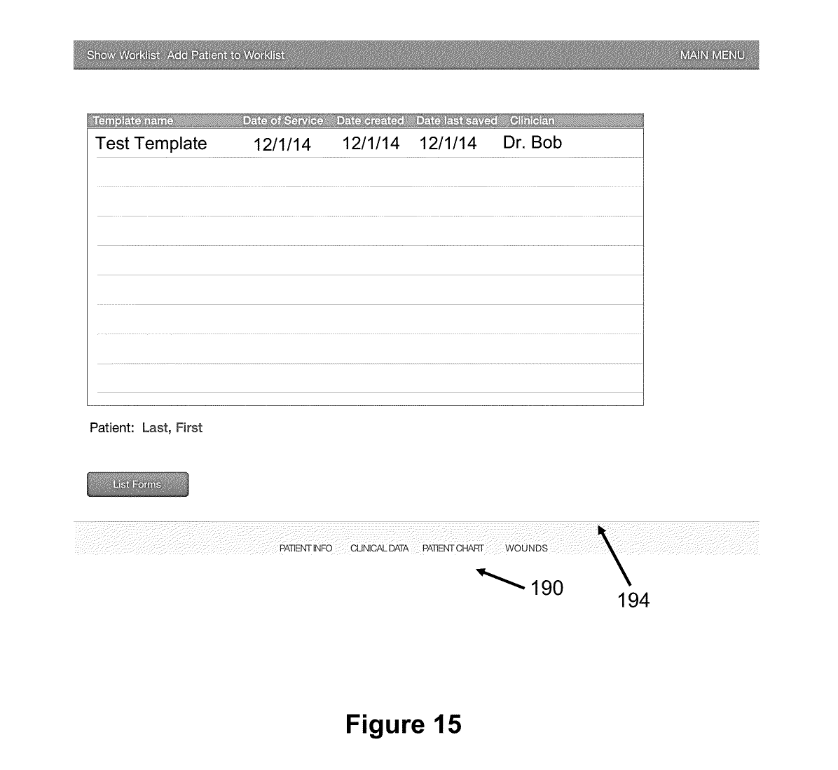

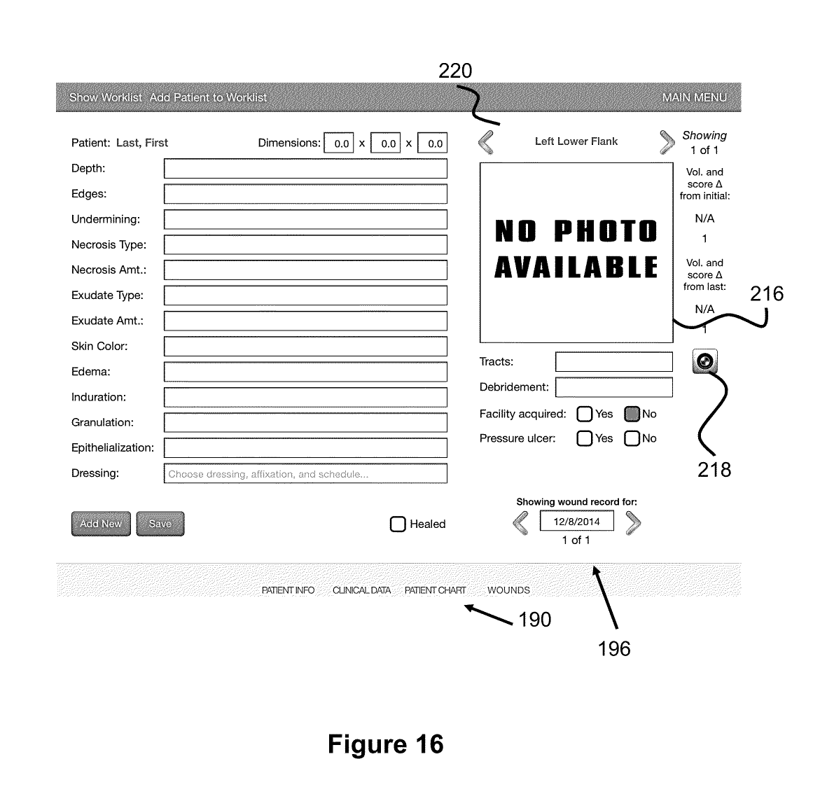

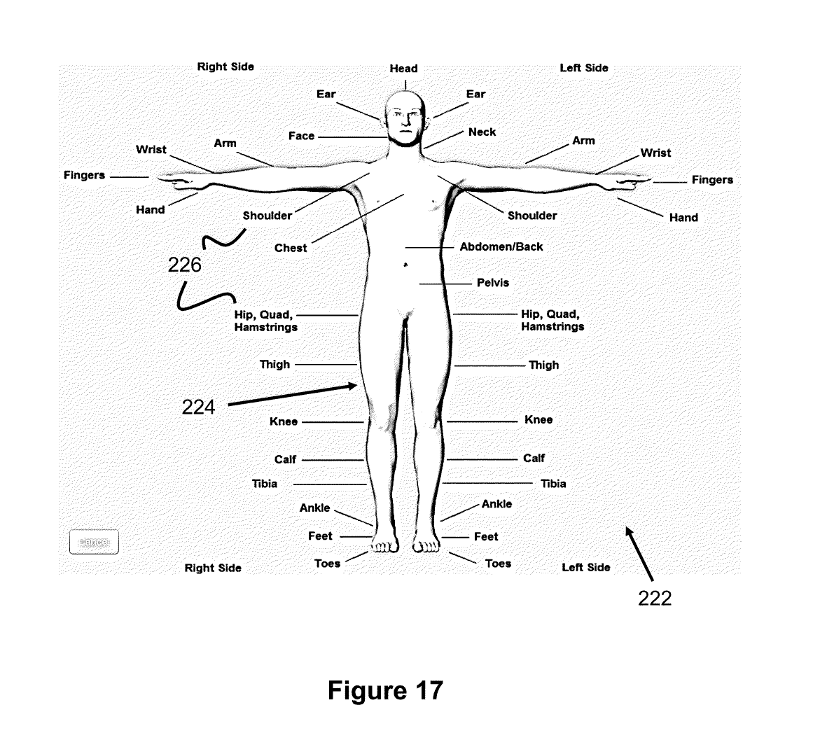

The worklist interface 182 includes a list area 184, which lists records by a patient's name and date of appointment. This list are 184 can be shown or hidden by actuating element 188. The worklist interface 182 also includes several navigation elements 190 that navigate between displaying a patient info interface 186 seen in FIG. 11, a clinical data interface 192 seen in FIG. 15, a patient chart interface 194 seen in FIG. 16, and a wound interface 196, seen in FIG. 17.

As seen in FIG. 11, the patient info interface 186 preferably includes a plurality of labels and input boxes relating to basic information about a patient, such as: last name, first name, account number, social security number, middle initial, sex, birth date, patient type, date of service, vital signs, problem list, agency location, record number, referring doctor, and clinician name. A photo element 198 may also be included so as to display a picture of the patient.

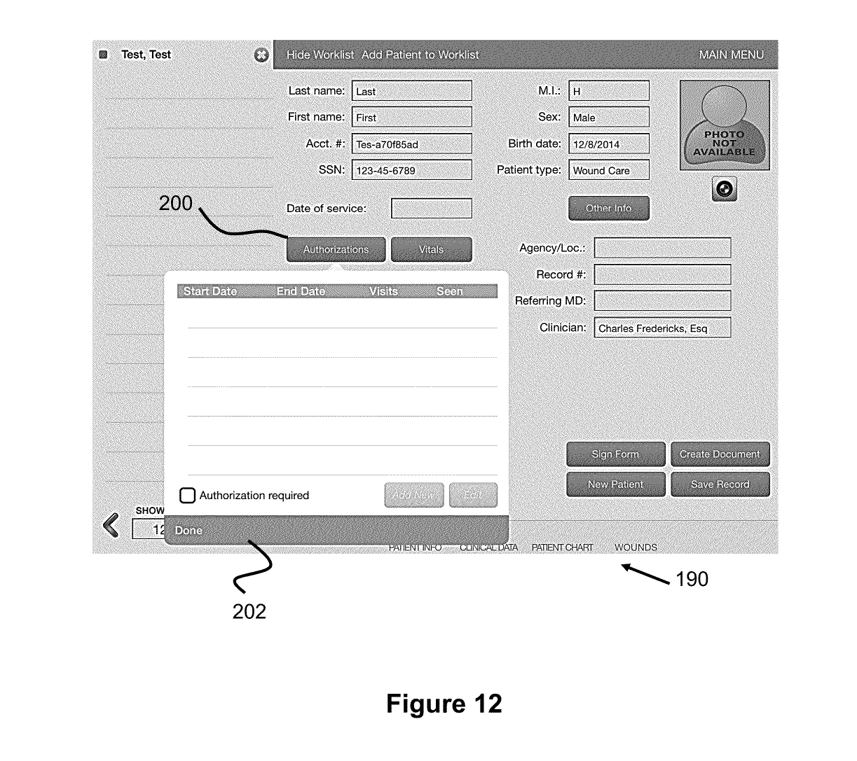

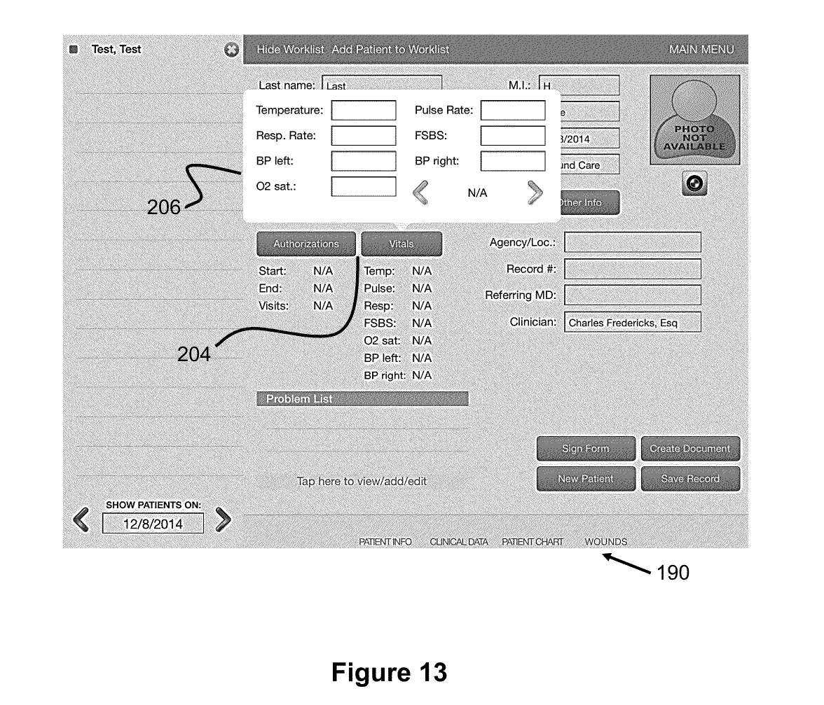

The patient info interface 186 also includes a plurality of button elements. Actuating the authorizations button element brings up an authorization interface window 202, as seen in FIG. 12, where specific authorizations can be inputted. Actuating the vitals button element 204 displays a vitals input interface window 206, as seen in FIG. 13, in which vitals such as patient temperature, respiration rate, blood pressure, oxygen saturation, pulse rate, and FSBS can be entered by the clinician.

By actuating the create document button element 208, the clinician is provided a list of each of the HTML template files that have been created by the medical group forms administrator and synced to the server 102. In this respect, the user can also input information into any of these HTML template forms, as necessary for a particular patient visit.

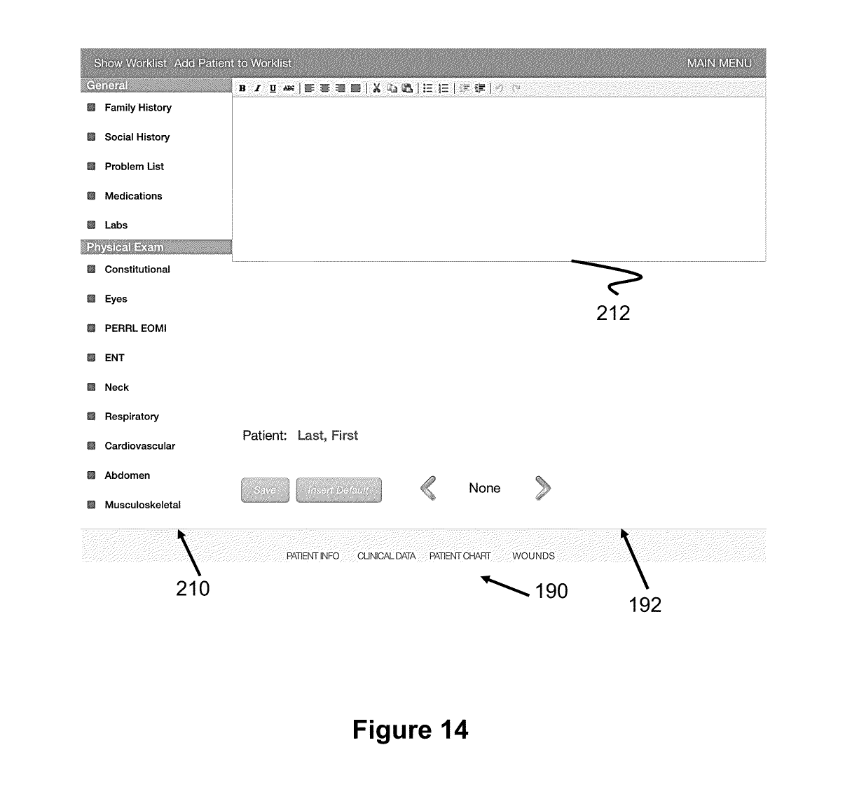

Turning to FIG. 14, the clinical data interface 192 provides a clinical data topic list 210 of specific clinical data items that, when selected, each have their own, large, formatted text input area 212. In this respect, the clinician can input information for each clinical item as necessary.

Turning to FIG. 15, the patient chart interface 194 lists any of the custom HTML templates that have been completed by the user and saved as a patient form. Actuating a listed form displays a window interface to edit or delete the listed form.

An acute wound has a normal wound physiology and is treated with the assumption that the wound will heal in normal stages. The progression through the normal process of wound healing consists of the following stages: hemostasis, inflammation, proliferation, and remodeling. In a basic description of each of the four stages in an acute wound the hemostasic stage begins the process of healing by sealing blood vessels through the use of platelets which clot and attach to collagen thereby sealing the damaged blood vessels. The subsequent inflammation stage is more of a response which causes the blood vessels to become leaky releasing plasma and polymorphonucleocytes into the surrounding tissue. Additionally macrophage cells secrete a variety of growth factors that direct the next stage of healing. The proliferative stage of the healing process is the rebuilding of the dermal and subdermal tissues of the skin where various cell types play a role to re-produce the framework for the skin and capillaries. And lastly, the remodeling stage of the healing process occurs upon completion of the basic structuring of the dermal tissues. In this phase fibroblast cells continually remodels the dermal tissues to produce greater tensile strength until the tissues are fully repaired.

Another form of a wound is known as a chronic wound. A basic explanation of a chronic wound is a wound that does not heal in an expected manner when compared to the acute wound healing process. Thus a chronic wound heals in various ways and often takes more time to heal. Additionally an acute wound may develop into a chronic wound in the event the normal healing process stalls in one of the normal stages of the acute wound healing process. There are many causes of chronic wounds which consist of diabetes, infection, vascular disease, radiation injury, etc. and they require intensive medical intervention and wound treatments are required to make the wound heal.

Both acute and chronic wound treatments need to be managed. In the event the wounds are managed by a medical professional such as a registered nurse or a doctor, they are done so by visits where the doctor can observe the wound. During the visit the medical professional will observe the wound for size, color, shape, depth, and texture. Additionally the medical professional will assess how the wound has progressed in the healing process and if a more intense treatment is required. Often times the medical professional is not able to accurately assess how the wound has progressed in the healing process if they don't recall the original size, color, shape, depth and texture or they were not the medical professional who last assessed the wound. Additionally, the size of the wound is medically important to validate that the wound is healing or if the wound is progressing in size or damage to the skin. Additionally, the medical professional often is paid by the medical insurance provider based on the physical size of the wound. This requires the medical professional to place a physical measuring device such as a ruler on the wound which may cause additional damage.

FIG. 16 illustrates the wound interface 196, which allows a clinician to enter a variety of information about a patient's wound, allowing the healing progress of the wound to be easily tracked over multiple visits. The interface 196 can include dimensions, depth, edges, undermining, necrosis type, necrosis amount, exudate type exudate amount, skin color, edema, induration, granulation, epithelialization, dressing, tracts, facility acquired, and pressure ulcer. Preferably, the interface 196 also includes a camera button element 218 that, when actuated, accesses the mobile computing device's camera, allowing the user to take and store a picture of the wound that will be displayed in photo area 216.

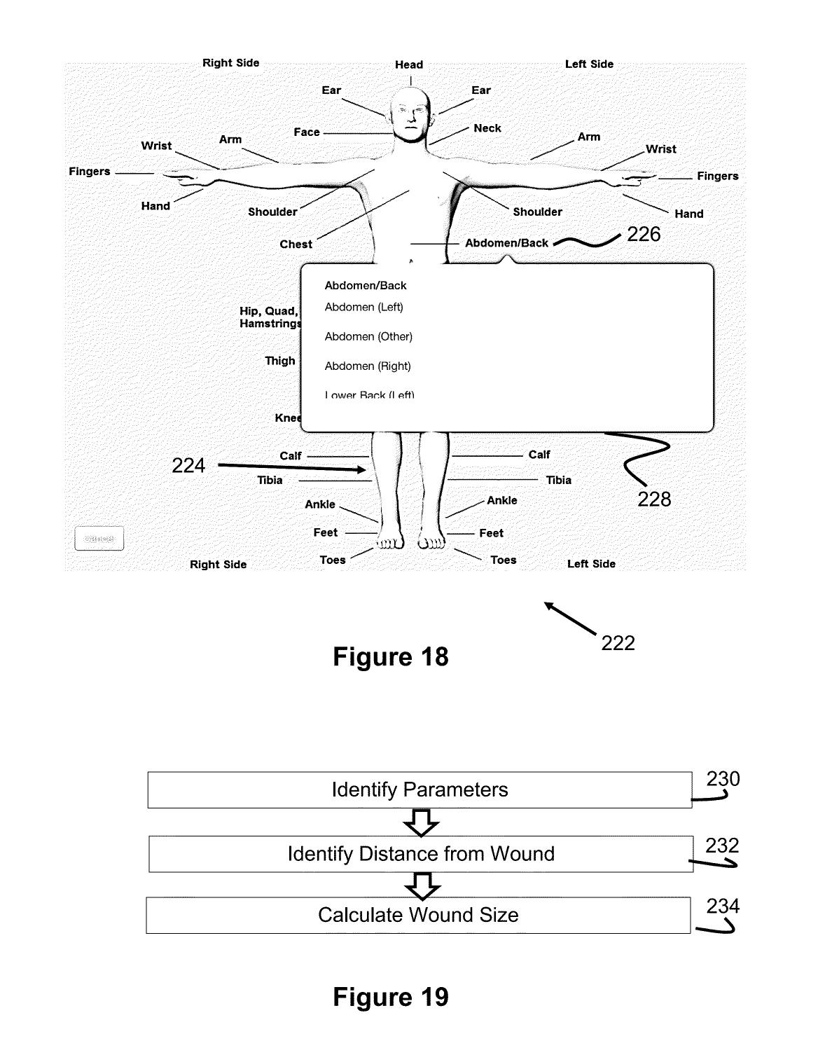

Actuating the wound location element 220 displays a wound location interface 222, seen in FIG. 17. In one embodiment, the interface 222 displays a graphical image 224 of a person with a plurality of text label elements 226. As seen in FIG. 18, when a user selects/actuates a text label element 226 for a general anatomical location, a sub-location window interface 228 is displayed, providing a list of specific anatomical locations within that general anatomical area of the selected text label element 226. In the example shown in FIG. 18, the “abdomen/back” is selected and the user can select one of several specific locations, such as “abdomen (left)”. In this respect, the clinician is able to quickly select a description for the wound location.

In another embodiment according to the present invention, the dimensions of a patient's wound can be automatically determined by the taking a picture of the wound (e.g., by actuating the camera button element 218 to activate the camera of the mobile computing device 108).

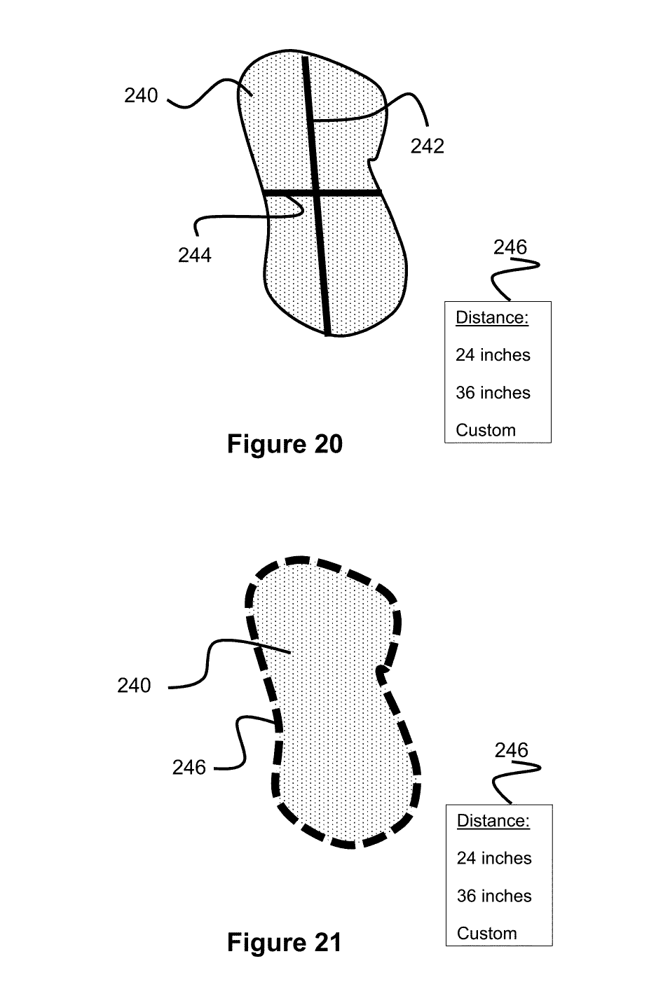

Referring to the flowchart in FIG. 19, the clinician first identifies the physical parameters or shape of the wound (element 230). This can be performed by first viewing either a live image of the wound on the mobile computing device 108 or a static image taken by the device 108. Next, the clinician inputs the wound shape. In one embodiment, this can be performed by drawing a horizontal line 244 and a vertical line 242 over the image of the wound 140, as seen in FIG. 20. For example, on a touch screen device, this can be performed by clinician moving their finger across the image of the wound 240. In another embodiment, the clinician can trace a line 246 around the outer bounds of the wound 240, as seen in FIG. 21.

Referring to element 232, the next step in the process is for the clinician to move the mobile device's camera over the wound at a predetermined distance. In one embodiment, the distance can be selected on the distance interface 246 for a predetermined distance (e.g., 24 inches) or a custom value. The camera of the mobile computing device 108 can then be moved to the specified distance (e.g., via measurement with a ruler or measuring tape.

In another embodiment, the distance can be determined by the application accessing the auto focusing mechanism of the camera of the mobile computing device 108. Since camera autofocusing mechanisms typically determine a distance from the camera lens to the photographed subject, this distance value provides a reasonable estimate of the distance for use in calculating the size of the wound 240.

Referring to element 234, once an accurate distance from the wound 240 is determined, the dimensions/size of the wound 234 can be determined. In one embodiment, the mobile application can be calibrated for an individual phone model, such that on-screen lengths and widths are known at different distances. In another embodiment, the user is directed to align indicia (e.g., crosshairs) with a first edge of the wound 240, and then move the mobile computing device to a second edge of the wound 240. An accelerometer on the device can measure the movement and create a distance estimate based on these readings.

Images of the wound can be archive within a medical database or within the mobile documentation system for the medical record for the patient with the wound 240. During a subsequent exam of the wound by a clinician, the wound imaging and dimensioning can be repeated. The clinician or other healthcare professional can compare multiple wound images to track the healing process.

In one embodiment, past wound images and dimensions can be manually compared to each other by the clinician. In another embodiment, the mobile software includes an algorithm to compare past wounds to each other and alert the clinician to any increase in wound size. Additionally, the mobile application can display multiple past wound images at the same time, for example, in a tile-type format or by partially-transparently displaying the images over each other. For the partially transparent wound display, the application is configured such that the user is provided with a scrolling bar or similar interface element to make one picture more transparent to the other. This enables the medical professional to compare color and depth of the wound and how the wound is healing. Due to the length of time it takes for wounds to heal fully and that wounds can be stalled at any stage of the healing process, the wound monitoring aspect of the mobile application enables the tracking and monitoring of the wound as it progresses through the healing process.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A medical records management system, comprising:
a server configured to store medical record files; and,
a computing device executing a word processor application and a medical records plug-in for said word processor application; said medical records plug-in displaying a clinical data interface window in which a plurality of clinical data elements are listed; said clinical data elements being actuatable to insert a content control element corresponding to said clinical data elements.

2. The medical records management system of claim 1, wherein said medical records plug-in is configured to transmit a word processing document containing said content control elements; and wherein said server is configured to convert said word processing document to an HTML template file.

3. The medical records management system of claim 2, further comprising a mobile computing device executing a medical record application; said medical record application configured to create a new patient form based on said HTML template file.

4. A wound management system, comprising:
a mobile computing device;
a wound management application executed on said mobile computing device; said wound management application having a wound identification interface displaying a graphical representation of a human and a plurality of text label elements describing anatomical locations on said graphical representation of a human; said text label elements being actuatable to display a sub-location window interface displaying a sub-location list of anatomical locations.

5. A wound management system, comprising:
a mobile computing device;
a wound management application executed on said mobile computing device; said wound management application configured to capture an image of a patient wound and calculate a size of said wound.

6. The wound management system of claim 5, wherein said wound management system calculates a size of said wound by identifying a shape of a wound and calculating a wound size.
